(19) United States
(12) Patent Application Publication
(10) Pub. No.: US 2024/0202724 A1
(43) Pub. Date: Jun. 20, 2024

(54) APPARATUS AND METHODS FOR IDENTIFICATION USING THIRD-PARTY VERIFIERS

(71) Applicant: The Beneficiary Liquidity Plan, Cornelius, NC (US)

(72) Inventor: Philip Graham, Cornelius, NC (US)

(73) Assignee: The Beneficiary Liquidity Plan, Cornelius, NC (US)

(21) Appl. No.: 18/085,021

(22) Filed: Dec. 20, 2022

(51) Int. Cl. G06Q 20/40; G06Q 20/02; G06V 10/772

(52) U.S. Cl. CPC G06Q 20/4014; G06Q 20/02; G06V 10/772

(57) ABSTRACT

The present disclosure is generally related to a method for based on identity verification, the method comprising: receiving a request for a payout from a second entity and receiving verification of a verifier, where receiving verification of the verifier may include receiving identifying data associated with the verifier where the identifying data comprises at least an image, and where the at least an image is a pixel array. The method may further include classifying the at least an image to a stored pixel array associated with an authorized verifier and confirming the identity of the verifier as an authorized verifier as a function of classifying the at least an image. Moreover, the method may include initiating the payout between a first entity and the second entity as a function of the verification and the request and performing, by the processor, the payout between the first entity and the second entity as a function of the verification.

### FIELD OF THE INVENTION

The present invention generally relates to the field of expedited insurance payout. In particular, the present invention is directed to an apparatus and method for payouts based on identity verification.

### BACKGROUND

Verification and authentication processes are susceptible to spoofing; where verification uses third-party participants, the potential risk can be amplified.

### SUMMARY OF THE DISCLOSURE

In an aspect, a method for identification using third-party verifiers may include receiving a request for a payout from a second entity and receiving verification of a verifier, where receiving verification of the verifier may include receiving identifying data associated with the verifier where the identifying data comprises at least an image, and where the at least an image is a pixel array. The method may further include classifying the at least an image to a stored pixel array associated with an authorized verifier and confirming the identity of the verifier as an authorized verifier as a function of classifying the at least an image. Moreover, the method may include initiating, the payout between a first entity and the second entity as a function of the verification and the request and performing, by the processor, the payout between the first entity and the second entity as a function of the verification.

In another aspect, an apparatus for identification using third-party verifiers may include at least a processor and a memory communicatively connected to the processor, the memory containing instructions configuring the at least a processor to receive a request for a payout from a second entity and receiving identifying data associated with the verifier, wherein receiving the identifying data comprises at least an image, and wherein the image is a pixel array. Further, the processor may be configured to classify the at least an image to a stored pixel array associated with an authorized verifier, and the identity of the verifier as an authorized verifier as a function of the at least an image. Moreover, the processor may be configured to initiate a payout between a first entity and the second entity as a function of the verification and perform the payout between the first entity and the second entity as a function of the verification.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment a system for transferring funds based on data verification;

FIG. 2 is a block diagram of an exemplary machine-learning process;

FIG. 3 is a diagram of an exemplary embodiment of a neural network;

FIG. 4 is a diagram of an exemplary embodiment of a node of a neural network;

FIG. 5 is a graph illustrating an exemplary relationship between fuzzy sets;

FIG. 6 is a flow diagram of an exemplary method for payouts based on identity verification; and

FIG. 7 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

In some instances, images may be used to authenticate a verifier may be susceptible to spoofs. To reduce the risks of spoofs, image classification may be utilized. Classifying images may be used to classify images received from verifiers as authenticated or non-authenticated by referencing a data store including authenticated verifier image data. In some instances, authenticated verifier image data store may be provided by an external source and/or be built-up by historical authenticated images. Exemplary embodiments illustrating aspects of the present disclosure are described below in the context of several specific examples.

In an embodiment, methods and systems described herein may perform or implement one or more aspects of a cryptographic system. In one embodiment, a cryptographic system is a system that converts data from a first form, known as “plaintext,” which is intelligible when viewed in its intended format, into a second form, known as “ciphertext,” which is not intelligible when viewed in the same way. Ciphertext may be unintelligible in any format unless first converted back to plaintext. In one embodiment, a process of converting plaintext into ciphertext is known as “encryption.” Encryption process may involve the use of a datum, known as an “encryption key,” to alter plaintext. Cryptographic system may also convert ciphertext back into plaintext, which is a process known as “decryption.” Decryption process may involve the use of a datum, known as a “decryption key,” to return the ciphertext to its original plaintext form. In embodiments of cryptographic systems that are “symmetric,” decryption key is essentially the same as encryption key: possession of either key makes it possible to deduce the other key quickly without further secret knowledge. Encryption and decryption keys in symmetric cryptographic systems may be kept secret and shared only with persons or entities that the user of the cryptographic system wishes to be able to decrypt the ciphertext. One example of a symmetric cryptographic system is the Advanced Encryption Standard (“AES”), which arranges plaintext into matrices and then modifies the matrices through repeated permutations and arithmetic operations with an encryption key.

In embodiments of cryptographic systems that are “asymmetric,” either encryption or decryption key cannot be readily deduced without additional secret knowledge, even given the possession of a corresponding decryption or encryption key, respectively; a common example is a “public key cryptographic system,” in which possession of the encryption key does not make it practically feasible to deduce the decryption key, so that the encryption key may safely be made available to the public. An example of a public key cryptographic system is RSA, in which an encryption key involves the use of numbers that are products of very large prime numbers, but a decryption key involves the use of those very large prime numbers, such that deducing the decryption key from the encryption key requires the practically infeasible task of computing the prime factors of a number which is the product of two very large prime numbers. Another example is elliptic curve cryptography, which relies on the fact that given two points P and Q on an elliptic curve over a finite field, and a definition for addition where A+B=−R, the point where a line connecting point A and point B intersects the elliptic curve, where “0,” the identity, is a point at infinity in a projective plane containing the elliptic curve, finding a number k such that adding P to itself k times results in Q is computationally impractical, given correctly selected elliptic curve, finite field, and P and Q.

In some embodiments, systems and methods described herein produce cryptographic hashes, also referred to by the equivalent shorthand term “hashes.” A cryptographic hash, as used herein, is a mathematical representation of a lot of data, such as files or blocks in a block chain as described in further detail below; the mathematical representation is produced by a lossy “one-way” algorithm known as a “hashing algorithm.” Hashing algorithm may be a repeatable process; that is, identical lots of data may produce identical hashes each time they are subjected to a particular hashing algorithm. Because hashing algorithm is a one-way function, it may be impossible to reconstruct a lot of data from a hash produced from the lot of data using the hashing algorithm. In the case of some hashing algorithms, reconstructing the full lot of data from the corresponding hash using a partial set of data from the full lot of data may be possible only by repeatedly guessing at the remaining data and repeating the hashing algorithm; it is thus computationally difficult if not infeasible for a single computer to produce the lot of data, as the statistical likelihood of correctly guessing the missing data may be extremely low. However, the statistical likelihood of a computer of a set of computers simultaneously attempting to guess the missing data within a useful timeframe may be higher, permitting mining protocols as described in further detail below.

In an embodiment, hashing algorithm may demonstrate an “avalanche effect,” whereby even extremely small changes to lot of data produce drastically different hashes. This may thwart attempts to avoid the computational work necessary to recreate a hash by simply inserting a fraudulent datum in data lot, enabling the use of hashing algorithms for “tamper-proofing” data such as data contained in an immutable ledger as described in further detail below. This avalanche or “cascade” effect may be evinced by various hashing processes; persons skilled in the art, upon reading the entirety of this disclosure, will be aware of various suitable hashing algorithms for purposes described herein. Verification of a hash corresponding to a lot of data may be performed by running the lot of data through a hashing algorithm used to produce the hash. Such verification may be computationally expensive, albeit feasible, potentially adding up to significant processing delays where repeated hashing, or hashing of large quantities of data, is required, for instance as described in further detail below. Examples of hashing programs include, without limitation, SHA256, a NIST standard; further current and past hashing algorithms include Winternitz hashing algorithms, various generations of Secure Hash Algorithm (including “SHA-1,” “SHA-2,” and “SHA-3”), “Message Digest” family hashes such as “MD4,” “MD5,” “MD6,” and “RIPEMD,” Keccak, “BLAKE” hashes and progeny (e.g., “BLAKE2,” “BLAKE-256,” “BLAKE-512,” and the like), Message Authentication Code (“MAC”)-family hash functions such as PMAC, OMAC, VMAC, HMAC, and UMAC, Poly 1305-AES, Elliptic Curve Only Hash (“ECOH”) and similar hash functions, Fast-Syndrome-based (FSB) hash functions, GOST hash functions, the Grøstl hash function, the HAS-160 hash function, the JH hash function, the RadioGatun hash function, the Skein hash function, the Streebog hash function, the SWIFFT hash function, the Tiger hash function, the Whirlpool hash function, or any hash function that satisfies, at the time of implementation, the requirements that a cryptographic hash be deterministic, infeasible to reverse-hash, infeasible to find collisions, and have the property that small changes to an original message to be hashed will change the resulting hash so extensively that the original hash and the new hash appear uncorrelated to each other. A degree of security of a hash function in practice may depend both on the hash function itself and on characteristics of the message and/or digest used in the hash function. For example, where a message is random, for a hash function that fulfills collision-resistance requirements, a brute-force or “birthday attack” may to detect collision may be on the order of O(2^{n/2}) for n output bits; thus, it may take on the order of 2256 operations to locate a collision in a 512 bit output “Dictionary” attacks on hashes likely to have been generated from a non-random original text can have a lower computational complexity, because the space of entries they are guessing is far smaller than the space containing all random permutations of bits. However, the space of possible messages may be augmented by increasing the length or potential length of a possible message, or by implementing a protocol whereby one or more randomly selected strings or sets of data are added to the message, rendering a dictionary attack significantly less effective.

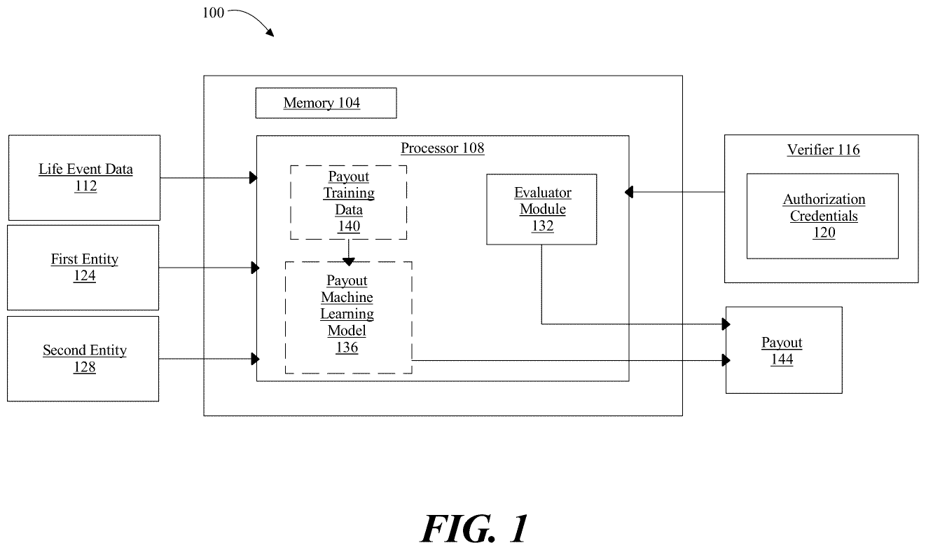

Continuing to refer to FIG. 1, a “secure proof,” as used in this disclosure, is a protocol whereby an output is generated that demonstrates possession of a secret, such as device-specific secret, without demonstrating the entirety of the device-specific secret; in other words, a secure proof by itself, is insufficient to reconstruct the entire device-specific secret, enabling the production of at least another secure proof using at least a device-specific secret. A secure proof may be referred to as a “proof of possession” or “proof of knowledge” of a secret. Where at least a device-specific secret is a plurality of secrets, such as a plurality of challenge-response pairs, a secure proof may include an output that reveals the entirety of one of the plurality of secrets, but not all of the plurality of secrets; for instance, secure proof may be a response contained in one challenge-response pair. In an embodiment, proof may not be secure; in other words, proof may include a one-time revelation of at least a device-specific secret, for instance as used in a single challenge-response exchange.

Secure proof may include a zero-knowledge proof, which may provide an output demonstrating possession of a secret while revealing none of the secret to a recipient of the output; zero-knowledge proof may be information-theoretically secure, meaning that an entity with infinite computing power would be unable to determine secret from output. Alternatively, zero-knowledge proof may be computationally secure, meaning that determination of secret from output is computationally infeasible, for instance to the same extent that determination of a private key from a public key in a public key cryptographic system is computationally infeasible. Zero-knowledge proof algorithms may generally include a set of two algorithms, a prover algorithm, or “P,” which is used to prove computational integrity and/or possession of a secret, and a verifier algorithm, or “V” whereby a party may check the validity of P. Zero-knowledge proof may include an interactive zero-knowledge proof, wherein a party verifying the proof must directly interact with the proving party; for instance, the verifying and proving parties may be required to be online, or connected to the same network as each other, at the same time. Interactive zero-knowledge proof may include a “proof of knowledge” proof, such as a Schnorr algorithm for proof on knowledge of a discrete logarithm. in a Schnorr algorithm, a prover commits to a randomness r, generates a message based on r, and generates a message adding r to a challenge c multiplied by a discrete logarithm that the prover is able to calculate; verification is performed by the verifier who produced c by exponentiation, thus checking the validity of the discrete logarithm. Interactive zero-knowledge proofs may alternatively or additionally include sigma protocols. Persons skilled in the art, upon reviewing the entirety of this disclosure, will be aware of various alternative interactive zero-knowledge proofs that may be implemented consistently with this disclosure.

Alternatively, zero-knowledge proof may include a non-interactive zero-knowledge, proof, or a proof wherein neither party to the proof interacts with the other party to the proof; for instance, each of a party receiving the proof and a party providing the proof may receive a reference datum which the party providing the proof may modify or otherwise use to perform the proof. As a non-limiting example, zero-knowledge proof may include a succinct non-interactive arguments of knowledge (ZK-SNARKS) proof, wherein a “trusted setup” process creates proof and verification keys using secret (and subsequently discarded) information encoded using a public key cryptographic system, a prover runs a proving algorithm using the proving key and secret information available to the prover, and a verifier checks the proof using the verification key; public key cryptographic system may include RSA, elliptic curve cryptography, ElGamal, or any other suitable public key cryptographic system. Generation of trusted setup may be performed using a secure multiparty computation so that no one party has control of the totality of the secret information used in the trusted setup; as a result, if any one party generating the trusted setup is trustworthy, the secret information may be unrecoverable by malicious parties. As another non-limiting example, non-interactive zero-knowledge proof may include a Succinct Transparent Arguments of Knowledge (ZK-STARKS) zero-knowledge proof. In an embodiment, a ZK-STARKS proof includes a Merkle root of a Merkle tree representing evaluation of a secret computation at some number of points, which may be 1 billion points, plus Merkle branches representing evaluations at a set of randomly selected points of the number of points; verification may include determining that Merkle branches provided match the Merkle root, and that point verifications at those branches represent valid values, where validity is shown by demonstrating that all values belong to the same polynomial created by transforming the secret computation. In an embodiment, ZK-STARKS does not require a trusted setup.

Zero-knowledge proof may include any other suitable zero-knowledge proof. Zero-knowledge proof may include, without limitation bulletproofs. Zero-knowledge proof may include a homomorphic public-key cryptography (hPKC)-based proof. Zero-knowledge proof may include a discrete logarithmic problem (DLP) proof. Zero-knowledge proof may include a secure multi-party computation (MPC) proof. Zero-knowledge proof may include, without limitation, an incrementally verifiable computation (IVC). Zero-knowledge proof may include an interactive oracle proof (IOP). Zero-knowledge proof may include a proof based on the probabilistically checkable proof (PCP) theorem, including a linear PCP (LPCP) proof. Persons skilled in the art, upon reviewing the entirety of this disclosure, will be aware of various forms of zero-knowledge proofs that may be used, singly or in combination, consistently with this disclosure.

In an embodiment, secure proof is implemented using a challenge-response protocol. In an embodiment, this may function as a one-time pad implementation; for instance, a manufacturer or other trusted party may record a series of outputs (“responses”) produced by a device possessing secret information, given a series of corresponding inputs (“challenges”), and store them securely. In an embodiment, a challenge-response protocol may be combined with key generation. A single key may be used in one or more digital signatures as described in further detail below, such as signatures used to receive and/or transfer possession of crypto-currency assets; the key may be discarded for future use after a set period of time. In an embodiment, varied inputs include variations in local physical parameters, such as fluctuations in local electromagnetic fields, radiation, temperature, and the like, such that an almost limitless variety of private keys may be so generated. Secure proof may include encryption of a challenge to produce the response, indicating possession of a secret key. Encryption may be performed using a private key of a public key cryptographic system or using a private key of a symmetric cryptographic system; for instance, trusted party may verify response by decrypting an encryption of challenge or of another datum using either a symmetric or public-key cryptographic system, verifying that a stored key matches the key used for encryption as a function of at least a device-specific secret. Keys may be generated by random variation in selection of prime numbers, for instance for the purposes of a cryptographic system such as RSA that relies prime factoring difficulty. Keys may be generated by randomized selection of parameters for a seed in a cryptographic system, such as elliptic curve cryptography, which is generated from a seed. Keys may be used to generate exponents for a cryptographic system such as Diffie-Helman or ElGamal that are based on the discrete logarithm problem.

Keys may be generated by random variation in selection of prime numbers, for instance for the purposes of a cryptographic system such as secret that relies prime factoring difficulty. Keys may be generated by randomized selection of parameters for a seed in a cryptographic system, such as elliptic curve cryptography, which is generated from a seed. Keys may be used to generate exponents for a cryptographic system such as Diffie-Helman or ElGamal that are based on the discrete logarithm problem.

Cryptographic system may be configured to generate a session-specific secret. Session-specific secret may include a secret, which may be generated according to any process as described above, that uniquely identifies a particular instance of an attested boot and/or loading of software monitor. Session-specific secret may include without limitation a random number. Session-specific secret may be converted to and/or added to a secure proof, verification datum, and/or key according to any process as described above for generation of a secure proof, verification datum, and/or key from a secret or “seed”; session-specific secret, a key produced therewith, verification datum produced therewith, and/or a secure proof produced therewith may be combined with module-specific secret, a key produced therewith, a verification datum produced therewith, and/or a secure proof produced therewith, such that, for instance, a software monitor and/or other signed element of attested boot and/or attested computing may include secure proof both of session-specific secret and of module-specific secret. In an embodiment, session-specific secret may be usable to identify that a given computation has been performed during a particular attested session, just as device-specific secret may be used to demonstrate that a particular computation has been produced by a particular device. This may be used, e.g., where secure computing module and/or any component thereof is stateless, such as where any such element has no memory that may be overwritten and/or corrupted.

A “digital signature,” as used herein, includes a secure proof of possession of a secret by a signing device, as performed on provided element of data, known as a “message.” A message may include an encrypted mathematical representation of a file or other set of data using the private key of a public key cryptographic system. Secure proof may include any form of secure proof as described above, including without limitation encryption using a private key of a public key cryptographic system as described above. Signature may be verified using a verification datum suitable for verification of a secure proof; for instance, where secure proof is enacted by encrypting message using a private key of a public key cryptographic system, verification may include decrypting the encrypted message using the corresponding public key and comparing the decrypted representation to a purported match that was not encrypted; if the signature protocol is well-designed and implemented correctly, this means the ability to create the digital signature is equivalent to possession of the private decryption key and/or device-specific secret. Likewise, if a message making up a mathematical representation of file is well-designed and implemented correctly, any alteration of the file may result in a mismatch with the digital signature; the mathematical representation may be produced using an alteration-sensitive, reliably reproducible algorithm, such as a hashing algorithm as described above. A mathematical representation to which the signature may be compared may be included with signature, for verification purposes; in other embodiments, the algorithm used to produce the mathematical representation may be publicly available, permitting the easy reproduction of the mathematical representation corresponding to any file.

In some embodiments, digital signatures may be combined with or incorporated in digital certificates. In one embodiment, a digital certificate is a file that conveys information and links the conveyed information to a “certificate authority” that is the issuer of a public key in a public key cryptographic system. Certificate authority in some embodiments contains data conveying the certificate authority's authorization for the recipient to perform a task. The authorization may be the authorization to access a given datum. The authorization may be the authorization to access a given process. In some embodiments, the certificate may identify the certificate authority. The digital certificate may include a digital signature.

In some embodiments, a third party such as a certificate authority (CA) is available to verify that the possessor of the private key is a particular entity; thus, if the certificate authority may be trusted, and the private key has not been stolen, the ability of an entity to produce a digital signature confirms the identity of the entity and links the file to the entity in a verifiable way. Digital signature may be incorporated in a digital certificate, which is a document authenticating the entity possessing the private key by authority of the issuing certificate authority and signed with a digital signature created with that private key and a mathematical representation of the remainder of the certificate. In other embodiments, digital signature is verified by comparing the digital signature to one known to have been created by the entity that purportedly signed the digital signature; for instance, if the public key that decrypts the known signature also decrypts the digital signature, the digital signature may be considered verified. Digital signature may also be used to verify that the file has not been altered since the formation of the digital signature.

With continued reference to FIG. 1, authorization credentials may include a time-varying authorization credentials, which may have a time limit after which time-varying authorization credentials is no longer valid. Time limit may be calculated from an initial time, which may be a datum linked to a particular timestamp or other value representing a fixed moment in time, associated with time-varying authorization credentials; initial time may be a time of creation, a time of verification, or other significant time relating to validity of time-varying token. Initial time may include, without limitation, a timestamp, which may include a secure timestamp, and/or a datum linked to a secure timestamp, such as a cryptographic hash of the secure timestamp or the like. As used herein, a “secure timestamp” is an element of data that immutably and verifiably records a particular time, for instance by incorporating a secure proof, cryptographic hash, or other process whereby a party that attempts to modify the time and/or date of the secure timestamp will be unable to do so without the alteration being detected as fraudulent.

In some embodiments, performing a trusted time evaluation may be performed by apparatus 100. As a non-limiting example, secure proof may be generated using a secure timestamp. Generating the secure timestamp may include digitally signing the secure timestamp using any digital signature protocol as described above. In one embodiment authenticity of received data signals is established by utilizing a chain of attestation via one or more attestation schemes (in nonlimiting example, via direct anonymous attestation (DAA)) to verify that a [product] is an authentic [product] that has the property of attested time. Generating a secure timestamp may be used to weed out spoofers or “man in the middle attacks.”

In some embodiments, secure timestamp may record the current time in a hash chain. In an embodiment, a hash chain includes a series of hashes, each produced from a message containing a current time stamp (i.e., current at the moment the hash is created) and the previously created hash, which may be combined with one or more additional data; additional data may include a random number. Additional data may include one or more additional data, including image data, location data, device data, network latency data that are received by processor 108. Additional data may be hashed into a Merkle tree or other hash tree, such that a root of the hash tree may be incorporated in an entry in hash chain. It may be computationally infeasible to reverse hash any one entry, particularly in the amount of time during which its currency is important; it may be astronomically difficult to reverse hash the entire chain, rendering illegitimate or fraudulent timestamps referring to the hash chain all but impossible. A purported entry may be evaluated by hashing its corresponding message. In an embodiment, the trusted timestamping procedure utilized is substantially similar to the RFC 3161 standard. In this scenario, the received data signals are locally processed at the listener device by a one-way function, e.g. a hash function, and this hashed output data is sent to a timestamping authority (TSA). The use of secure timestamps as described herein may enable systems and methods as described herein to instantiate attested time. Attested time is the property that a device incorporating a local reference clock may hash data, e.g. image data, location data, device data, network latency data, along with the local timestamp of the device. Attested time may additionally incorporate attested identity, attested device architecture and other pieces of information identifying properties of the attesting device. In one embodiment, secure timestamp is generated by a trusted third party (TTP) that appends a timestamp to the hashed output data, applies the TSA private key to sign the hashed output data concatenated to the timestamp, and returns this signed, a.k.a. trusted timestamped data back to the listener device. Alternatively, or additionally, one or more additional participants, such as other verifying nodes, may evaluate secure timestamp, or other party generating secure timestamp and/or perform threshold cryptography with a plurality of such parties, each of which may have performed an embodiment of method to produce a secure timestamp. In an embodiment, database or other parties authenticating digitally signed assertions, devices, and/or user credentials may perform authentication at least in part by evaluating timeliness of entry and/or generation data as assessed against secure timestamp. In an embodiment, secure proof is generated using an attested computing protocol; this may be performed, as a non-limiting example, using any protocol for attested computing as described above.

Some embodiments disclosed herein are directed to systems and methods for expedited insurance payout. In some instances, significant life events may cause the need for an insurance claim to be made either by the insured person(s) or legal beneficiaries of the insured person(s). However, typical insurance payouts take significant amounts of time. In order to expedite payouts, insurance claims may include one or more verifications from a licensed professional that may enable insurance payouts to occur quicker than previously used methods. In some instances, payouts may occur in under 48 hours from the reception of one or more verifications from a licensed professional.

In some instances, payouts may be delayed due to lack of authentication of third-party authenticators. Third party authenticators may provide authentication credentials to confirm their identity in order to verify one or more claims. However, to prevent any fraudulent claims from being verified, or any fraudulent authenticators being allowed to verify a payout, a more secure authentication method may be desired. As mentioned above, receiving verification of an authenticator along with authentication of a claim may lead to a faster payout to the person(s) requesting the payout. Advantageously, computing resources needed to complete a payout may be reduced and/or repurposed to creating unique authentication credentials and deciphering the same unique credentials.

Referring now to FIG. 1, an exemplary embodiment of an apparatus 100 for payouts based on identity verification is illustrated. Apparatus 100 includes a memory 104. Memory 104 may be communicatively connected to the at least a processor 108. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure. Memory contains instructions configuring the at least a processor 108 to perform one or more steps as discussed throughout this disclosure.

Still referring to FIG. 1, apparatus may include processor 108 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Processor 108 may include a single computing device operating independently, or may include two or more computing device operating in concert, in parallel, sequentially or the like; two or more computing devices may be included together in a single computing device or in two or more computing devices. Processor 108 may interface or communicate with one or more additional devices as described below in further detail via a network interface device. Network interface device may be utilized for connecting processor 108 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 108 may include but is not limited to, for example, a computing device or payout of computing devices in a first location and a second computing device or payout of computing devices in a second location. Processor 108 may include one or more computing devices dedicated to data storage, security, distribution of traffic for load balancing, and the like. Processor 108 may distribute one or more computing tasks as described below across a plurality of computing devices of computing device, which may operate in parallel, in series, redundantly, or in any other manner used for distribution of tasks or memory between computing devices. Processor 108 may be implemented using a “shared nothing” architecture in which data is cached at the worker, in an embodiment, this may enable scalability of apparatus 100 and/or computing device.

With continued reference to FIG. 1, processor 108 may be designed and/or configured to perform any method, method step, or sequence of method steps in any embodiment described in this disclosure, in any order and with any degree of repetition. For instance, processor 108 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. processor 108 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, processor 108 may receive life event data 112. As used in this disclosure, “life event data” is data concerning a significant change in a person's life that alters their daily routine. As a non-limiting example, life event data 112 may include but not be limited to injuries, marriage, divorce, death, childbirth, inheritance, insurance policies, beneficiaries, claim history or things of the like. Life event data 112 may be input to processor 108 by a user. In some embodiments life event data 112 may be input to processor 108 by processor 108 sending a query for life event data to one or more user devices. As a non-limiting example, processor 108 may send a query periodically to acquire life event data 112.

Still referring to FIG. 1, processor may receive life event data 112 from a licensed professional. As a non-limiting example, a licensed professional, such as a licensed mortician, may send an indication of a person's death to processor 108. In some instances, licensed professional may automatically send an indication corresponding to life event data 112 upon completion of a life event. As a non-limiting example, licensed professional may send an indication to processor 108 that a person has been married. In some embodiments, life event data 112 may include one or more claims submitted by a user. One or more claims may be an indication of one or more life events occurring.

Still referring to FIG. 1, for instance, and without limitation, a life event data 112 may be stored in a memory or a database. Life event data 112 may be recalled from the memory or database through a search query for any existing life insurance policies under the insured's legal name or identifier (e.g., insurance company code associated with the insured, social security number, and the like).

Still referring to FIG. 1, in another instance, life event data 112 may be identified by a beneficiary or owner and provided via user input. For example, and without limitation, the person may provide the life event data 112 as a hardcopy, by inputting information related to the life event data 112 into a graphical user interface (GUI) of a computing device, by scanning an original copy of the life event data 112 (e.g., uploading an image or .pdf of a hardcopy of the life event data 112), and the like.

Continuing to refer to FIG. 1, processor 108 may receive verification of live event data 112 from verifier 116. As used in this disclosure, “verifier” is an entity that has the ability to confirm that life event data is accurate. In some instances, verification may be received from one or more verifiers 116. Verification may include authorization credentials 120 from verifier 116 or one or more verifiers. As used in this disclosure, “authorization credentials” is information or data that confirms or seeks to confirm that a verifier is licensed or certified to verify life event data. Authorization credentials may include, as non-limiting examples, passwords, usernames, secret codes, pins, answers to secret questions, RSA codes, ID cards, diplomas, certificates, images of verifiers, fingerprints, eye scans, and the like. As a non-limiting example, authorization credentials 120 may confirm that verifier 116 is a licensed professional, certified authority, authorized personnel, or things of the like. In some instances, verifier 116 may the same entity that provides life event data 112. In such instance, processing power may be reduced since life event data 112, verification of life event data 112 from verifier 116, and authorization credentials 120 of verifier 116 may be provided simultaneously.

Still referring to FIG. 1, verifier 116 may provide a formal statement or certificate confirming the death of the insured. The statement or certificate may be created by an approved professional (e.g., licensed professional), such as a funeral director, undertaker, mortician, and/or coroner. The approved professional may be prompted to verify the death of the insured by; for example, and without limitation, an automated call, message, or email, which may be simultaneously generated with the request for payout. The approved professional may create the formal statement or certificate by, for example, filling out a questionnaire, selecting options from a provided list, providing stamps or watermarks, providing a signature (with or without a notary), any combination thereof, and the like. In some embodiments, a list may be provided by the insurance company of preapproved professionals. The list of approved professionals may be organized according to job title, qualifications, geographical location, pricing, and the like. In other embodiments, a background check of the approved professional may be conducted to confirm that the individual is a licensed and/or trusted professional

With continued reference to FIG. 1, processor 108 may receive entity data from a first entity 124, second entity 128, or both. As used in this disclosure, “first entity” is an entity that pays out premiums. As a non-limiting example, first entity 124 may be an insurance provider that pays out premiums based on claims submitted to the insurance provider. As used in this disclosure, “second entity” is an entity that is entitled or believes it is entitled to the premiums. As a non-limiting example, second entity 128 may be an insured person or a beneficiary that receives payment from an insurance provider. Entity data may be provided by a user to processor 108. In some instances, entity data may be acquired by processor 108 by scanning user devices. In some embodiments, first entity 124 data may be received simultaneously with verification from verifier 116. One of ordinary skill in the art, upon reading this disclosure, would know the different combinations of timing in which data may be received by processor 108.

Still referring to FIG. 1, first entity 124 and second entity 128 may send entity data to evaluator module 132. Evaluator module 132 may receive entity data, life event data 112, verification from verifier 116, authorization credentials, or any combination thereof. As used in this disclosure, “evaluator module” is a module that evaluates life event data and determines whether a payout is warranted or not. As a non-limiting example, evaluator module 132 may receive life event data 112, first entity 124 data, second entity 128 data, and verification for verifier 116 indicating that a person has passed away. Accordingly, evaluator module 132 may determine that life event data 112 is accurate based on verifier 116 and confirm that verifier 116 is authorized to verify life event data 112 by evaluating authorization credentials 120. Evaluator module 132 may determine that second entity 128 is associated with the person who passed away or a beneficiary of the person who passed away. Evaluator module 132 may determine that first entity 124 is associated with an insurance provider that provided insurance to the person who passed away. Evaluator module 132 may do this by scanning the transaction history between first entity 124 and second entity 128 to determine if monthly payments have occurred. This may verify that a payout in response to life event data 112 may be warranted. In some embodiments, evaluator module 132 may be utilized to prevent fraudulent attempts. As a non-limiting example, evaluator module 132 may determine that life event data 112 is inaccurate, verifier is not authorized, the first entity 124 and second entity 128 do not match, or things of the like. Thus, indicating that a fraudulent attempt to receive an insured person's funds has been made. It should be noted that the multi-step verification process may create redundancies and thus create a more secure verification process for insurance payouts.

Still referring to FIG. 1, evaluator module 132 may receive assistance from one or more persons associated with and/or related to the insured to identify the insured. The persons may provide the evaluator module 132 with officially issued documents or authenticated information to assist with identifying the insured (e.g., government identification, driver's license, birth certificate, hospital statements or records, social security card, photograph(s), DNA results, and the like).

Still referring to FIG. 1, evaluator module 132 may receive verification of an identity of a verifier 116. It should be noted that the evaluator module may analyze authorized credentials 120 to verify the identity of verifier 116. In some embodiments, evaluator module 132 may confirm verifier via facial recognition. Verification of verifier 116 may be done by using facial recognition software or voice recognizing software. As used in the current disclosure, “facial recognition software” a technology capable of matching a human face from a digital image or a video frame against a database of faces, typically employed to authenticate users through ID verification services, works by pinpointing and measuring facial features from a given image. Computerized facial recognition involves the measurement of a character's physiological characteristics, facial recognition systems are categorized as biometrics. In some embodiments, facial scans of verifier 116 may be compared to a database of authorized users provided by first entity 124. In some instances, a database of authorized users may be provided by second entity 128.

Referring again to FIG. 1, apparatus 100 may be designed and configured to perform at least a machine-learning process to perform one or more determinations and/or other process steps described in this disclosure, including without limitation relation of images to anatomical features, classification of image data to demographic traits, image quality traits, and/or other traits and/or attributes, or the like. A “machine learning process,” as used in this disclosure, is a process that automatedly uses a body of data known as “training data” and/or a “training set” to generate an algorithm that will be performed by a computing device/module to produce outputs given data provided as inputs; this is in contrast to a non-machine learning software program where the commands to be executed are determined in advance by a user and written in a programming language.” For instance, and without limitation, processor 108 may be configured create at least a machine-learning model 136 and/or enact a machine-learning process relating images of anatomical features to labels of anatomical features using the training set and generating the at least an output using the machine-learning model 136; at least a machine-learning model 136 may include one or more models that determine a mathematical relationship between images of anatomical features and labels of anatomical features. Such models may include without limitation model developed using linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

With continued reference to FIG. 1, to perform facial recognition, processor 108 may receive image data and/or video data associated with verifier 116. In some embodiments, image and/or video data may be generated by a camera. As used in this disclosure, a “camera” is a device that is configured to sense electromagnetic radiation, such as without limitation visible light, and generate an image representing the electromagnetic radiation. In some cases, a camera may include one or more optics. Exemplary non-limiting optics include spherical lenses, aspherical lenses, reflectors, polarizers, filters, windows, aperture stops, and the like. In some cases, at least a camera may include an image sensor. Exemplary non-limiting image sensors include digital image sensors, such as without limitation charge-coupled device (CCD) sensors and complimentary metal-oxide-semiconductor (CMOS) sensors, chemical image sensors, and analog image sensors, such as without limitation film. In some cases, a camera may be sensitive within a non-visible range of electromagnetic radiation, such as without limitation infrared. As used in this disclosure, “image data” is information representing at least a physical scene, space, and/or object. In some cases, image data may be generated by a camera. “Image data” may be used interchangeably through this disclosure with “image,” where image is used as a noun. An image may be optical, such as without limitation where at least an optic is used to generate an image of an object. An image may be material, such as without limitation when film is used to capture an image. An image may be digital, such as without limitation when represented as a bitmap. Alternatively, an image may be comprised of any media capable of representing a physical scene, space, and/or object. Alternatively where “image” is used as a verb, in this disclosure, it refers to generation and/or formation of an image. In some embodiments, camera may be a component of apparatus 100. In some embodiments, camera may use any wireless communication technology disclosed in this disclosure to transmit image data and/or video data to apparatus 100 and/or processor 108. Wireless communication technology may include radio, Bluetooth, Wi-Fi, mobile data, 3G, 4G, LTE, 5G, NFC, and the like.

With continued reference to FIG. 1, processor 108 may utilize facial recognition software to processor image and/or video data. Facial recognition software may be utilized using any process described in this disclosure. As a non-limiting example, processor 108 may extract values from image and/or video data received from verifier 116. Processor 108 may then compare the extracted values and compare them to a database storing image and/or video data of authorized users. In some embodiments a device associated with verifier 116 may utilize facial recognition software and send extracted values to processor 108 for comparison. This may advantageously reduce computational power and time need to verify verifier 116.

Still referring to FIG. 1, evaluator module 132 may verify verifier 116 by analyzing textual input. In some embodiments, optical character recognition or optical character reader (OCR) includes automatic conversion of images of written (e.g., typed, handwritten or printed text) into machine-encoded text. In some cases, recognition of at least a keyword from an image component may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine learning processes. In some cases, intelligent word recognition (IWR) may recognize written text, one word at a time, for instance by employing machine learning processes.

Still referring to FIG. 1, in some cases OCR may be an “offline” process, which analyses a static document or image frame. In some cases, handwriting movement analysis can be used as input to handwriting recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition.

Still referring to FIG. 1, in some cases, OCR processes may employ pre-processing of image component. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to image component to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from a background of image component. In some cases, binarization may be required for example if an employed OCR algorithm only works on binary images. In some cases. a line removal process may include removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify script allowing an appropriate OCR algorithm to be selected. In some cases, a character isolation or “segmentation” process may separate signal characters, for example character-based OCR algorithms. In some cases, a normalization process may normalize aspect ratio and/or scale of image component.

Still referring to FIG. 1, in some embodiments an OCR process will include an OCR algorithm. Exemplary OCR algorithms include matrix matching process and/or feature extraction processes. Matrix matching may involve comparing an image to a stored glyph on a pixel-by-pixel basis. In some case, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at a same scale as input glyph. Matrix matching may work best with typewritten text.

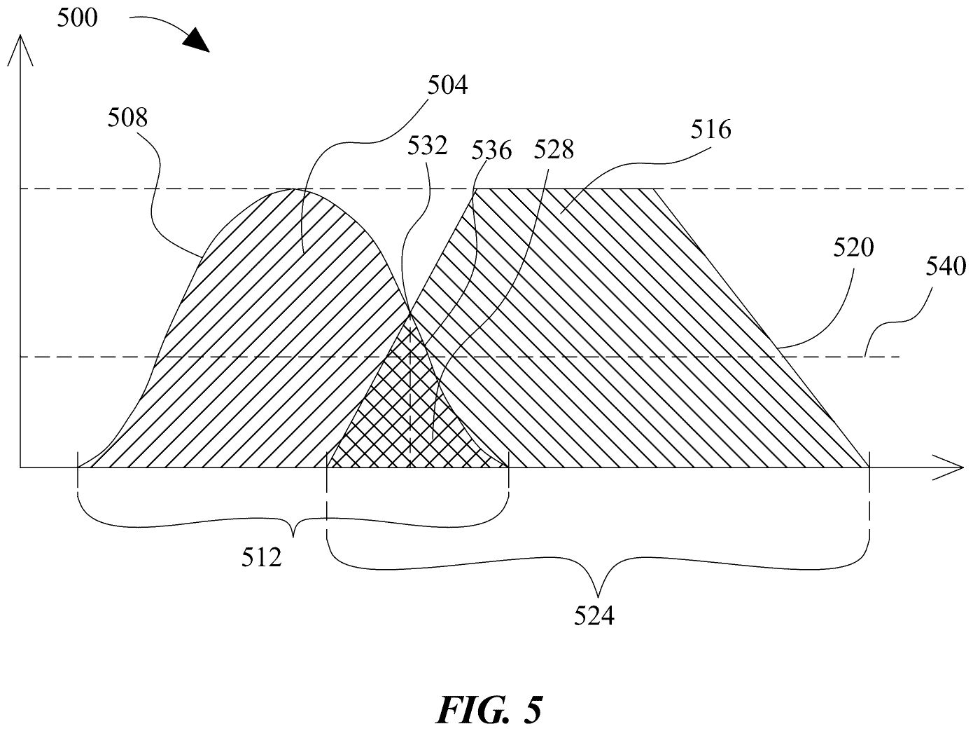

Still referring to FIG. 1, in some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted feature can be compared with an abstract vector-like representation of a character, which might reduce to one or more glyph prototypes. General techniques of feature detection in computer vision are applicable to this type of OCR. In some embodiments, machine-learning process like nearest neighbor classifiers (e.g., k-nearest neighbors algorithm) can be used to compare image features with stored glyph features and choose a nearest match. OCR may employ any machine-learning process described in this disclosure, for example machine-learning processes described with reference to FIGS. 5-8. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

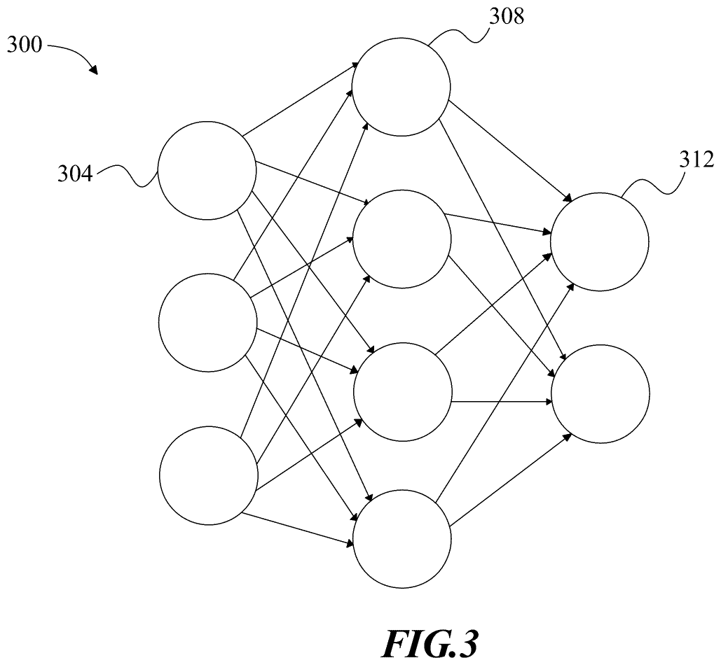

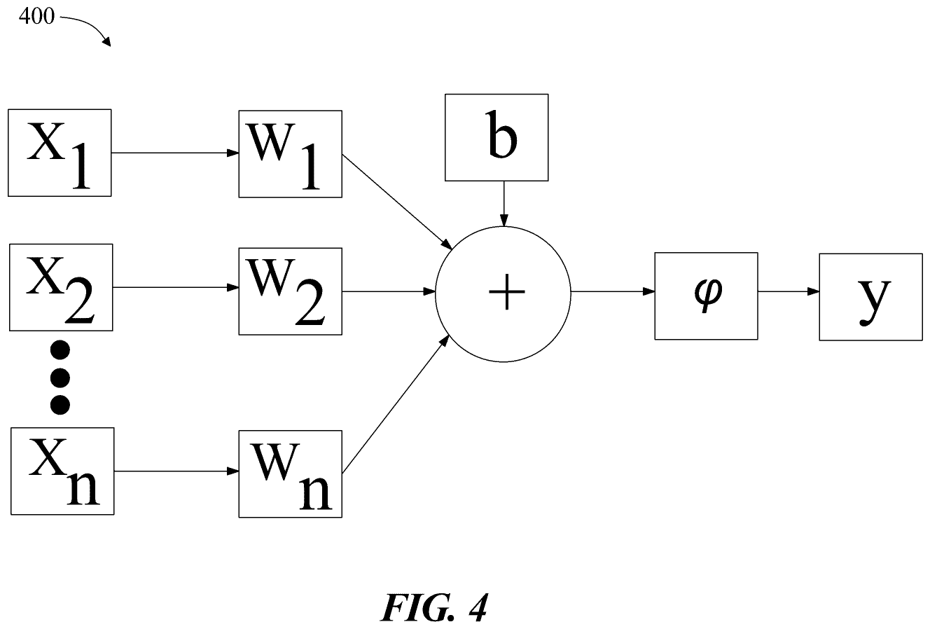

Still referring to FIG. 1, in some cases, OCR may employ a two-pass approach to character recognition. Second pass may include adaptive recognition and use letter shapes recognized with high confidence on a first pass to recognize better remaining letters on the second pass. In some cases, two-pass approach may be advantageous for unusual fonts or low-quality image components where visual verbal content may be distorted. Another exemplary OCR software tool include OCRopus. OCRopus development is led by German Research Centre for Artificial Intelligence in Kaiserslautern, Germany. In some cases, OCR software may employ neural networks, for example neural networks as taught in reference to FIGS. 3 and 4.

Still referring to FIG. 1, in some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make use of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

Still referring to FIG. 1, processor 108 may receive a textual input from verifier 116. In some embodiments, textual input may include authorized credentials 120. In some instances, textual input may be a character string unique to verifier 116. As a non-limiting example, when compiling a list or database of authorized users, processor 108 may distribute unique authorized credentials 120 to each of the authorized users. Thus, each authorized user may receive a unique credential to use for later verifications. Upon submitting a verification, verifier may provide the unique authorized credential 120 to processor 108. In some embodiments, authorized credentials 120 may be an image, such as without limitation an image of a verifier. Image may be any image containing data that may be extracted by processor 108 using OCR. As a non-limiting example, image may include an image of an ID card, credit card, social security card, or any other suitable credential. Authorized credential 120 that may be an image may be provided to verifier 116 upon creating of a list or database of authorized users, as described herein. It should be noted that processor 108 may create a series of unique authorization credentials 120, store them in a database, and send all the unique authorization credentials 120 to their respective verifiers 116 in real-time.

With continued reference to FIG. 1, by creating the authorization credentials simultaneously, the probability of creating a duplicate may be lessened. Upon reading this disclosure, one of ordinary skill in the art would understand that the credentials analyzed by OCR techniques may create complex authorized credentials that may prevent fraudulent attempts to receive payouts. In some embodiments, authorization credentials 120 may be encrypted. In some instances, encrypted authorization credentials may be compared to stored encrypted authorization credentials to authenticate verifier 116. In some embodiments, authorization credentials 120 may be encrypted initially and decrypted to compare to decrypted stored authorization credentials. Encrypting authorization credentials may serve as an additional fail-safe for fraudulent payout request. Additionally, encryption may compress an amount of data transferred across a network. Thus, encryption of authorization credentials 120 may reduce time elapsed during packet transmission. Upon reading this disclosure, one of ordinary skill in the art would know the various methods for encrypting authorization credentials.

With continued reference to FIG. 1, in some embodiments, authentication of the verifier may include authentication thereof using an authentication machine learning model. Authentication machine learning model may be consistent with any other machine learning model disclosed in this disclosure. Authentication machine learning model may be trained using verification training data. Authentication training data may include authorization credentials of verifiers correlated to verification status data. In some embodiments, authorization credentials in verification training data may include images of verifiers, ID cards, certificates, diplomas, and the like. In some embodiments, authorization credentials in verification training data may be processed using OCR as discussed above; in other words, OCR process may be used to generate textual data from a plurality of documents entered as training examples, such as past documents. An “authentication status,” for the purposes of this disclosure, is a datum indicating whether or not a verifier is authenticated. For example, verification status may include “yes,” “no,” and/or “indeterminate.” Authentication machine learning model may be configured to take authorization credentials as input and output verification statuses. Processor 108 may be configured to input the authorization credential 120 of the verifier 116 and receive as output from the verification machine learning model a verification status. With continued reference to FIG. 1, life event data 112, first entity 124, second entity 128, verifier 116, authorization credentials 120, or any combination thereof may be inputs to a payout machine learning model 136. Payout machine learning model 136 may be any suitable machine learning model as described in this disclosure. Payout machine learning model 136 may be trained using payout training data 140. Payout training data 140 may correlate life event data 112, first entity 124, and second entity 128 to payout 144. In some instances, payout training data 140 may correlate insurance policy data, first entity 124, and second entity 128 to payout 144. In some embodiments, payout training data 140 may be received by user input or input by an insurance provider. In some instances, payout training data 140 may be automatically received by processor 108 from insurance provider and/or an insured person or their beneficiary. Trained payout machine learning model 136 may receive life event data 112, first entity 124 data, and second entity data 128 and determine a payout 144 by using machine learning methods described herein. As used in this disclosure, “payout” is a disbursement of funds from a first entity to a second entity. In an embodiment, payouts may be a one-time disbursement, a recurring disbursement, and the like.

Still referring to FIG. 1, authentication may include, without limitation, matching image data to known and/or verified image data, such as without limitation a stored, previously authenticated, and/or user verified image of a verifier and/or authorized person. Image classifier may include without limitation any classifier as described in this disclosure. Image classifier may be trained, without limitation, using training data containing images of a type to be matched, such as images of faces, with user-entered or otherwise generated indications of identity, images of matching and non-matching faces or other matter, or the like; thus image classifier may be trained to detect whether a face depicted in a given image matches a face depicted in a stored image, or otherwise match a subject of an image to a subject of another image.

Continuing to refer to FIG. 1, processor 108 may use interpolation and/or upsampling methods to process authorization credentials 120. For instance, where authentication credentials include image data, processor 108 may convert a low pixel count image into a desired number of pixels need to for input into an image classifier; as a non-limiting example, an image classifier may have a number of inputs into which pixels are input, and thus may require either increasing or decreasing the number of pixels in an image to be input and/or used for training image classifier, where interpolation may be used to increase to a required number of pixels. As a non-limiting example, a low pixel count image may have 100 pixels, however a number of pixels needed for an image classifier may be 128. Processor 108 may interpolate the low pixel count image to convert the 100 pixels into 128 pixels so that a resultant image may be input into an image classifier. It should be noted that image classifier may be any classifier as described in this disclosure. It should also be noted that one of ordinary skill in the art, upon reading this disclosure, would know the various methods to interpolate a low pixel count image to a desired number of pixels required by an image classifier. In some instances, a set of interpolation rules may be trained by sets of highly detailed images and images that may have been downsampled to smaller numbers of pixels, for instance and without limitation as described below, and a neural network or other machine learning model that is trained using the training sets of highly detailed images to predict interpolated pixel values in a facial picture context. As a non-limiting example, a sample picture with sample-expanded pixels (e.g., pixels added between the original pixels) may be input to a neural network or machine-learning model and output a pseudo replica sample-picture with dummy values assigned to pixels between the original pixels based on a set of interpolation rules. In some instances, image classifier and/or another machine-learning model may have a set of interpolation rules trained by sets of highly detailed images and images that have been downsampled to smaller numbers of pixels, and a neural network or other machine learning model that is trained using those examples to predict interpolated pixel values in a facial picture context. I.e., you run the picture with sample-expanded pixels (the ones added between the original pixels, with dummy values) through this neural network or model and it fills in values to replace the dummy values based on the rules

Still referring to FIG. 1, processor 108 may utilize sample expander methods, a low-pass filter, or both. As used in this disclosure, a “low-pass filter” is a low-pass filter is a filter that passes signals with a frequency lower than a selected cutoff frequency and attenuates signals with frequencies higher than the cutoff frequency. The exact frequency response of the filter depends on the filter design. In some embodiments, processor 108 may use luma or chroma averaging to fill in pixels in between original image pixels. Processor 108 may down-sample image data to a lower number of pixels to input into an image classifier. As a non-limiting example, a high pixel count image may have 256 pixels, however a number of pixels need for an image classifier may be 128. Processor 108 may down-sample the high pixel count image to convert the 256 pixels into 128 pixels so that a resultant image may be input into an image classifier.

In some embodiments, and with further reference to FIG. 1, processor may be configured to perform downsampling on data such as without limitation image data. For instance, and without limitation, where an image to be input to image classifier, and/or to be used in training examples, has more pixel than a number of inputs to such classifier. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Continuing to refer to FIG. 1, payout training data 140 may include two or more sets of image quality-linked training data. “Image quality-linked” training data, as described in this disclosure, is training data in which each training data element has a degree of image quality, according to any measure of image quality, matching a degree of image quality of each other training data element, where matching may include exact matching, falling within a given range of an element which may be predefined, or the like. For example, a first set of image quality-linked training data may include images having no or extremely low blurriness, while a second set of image quality-linked training data. In an embodiment, sets of image quality-linked training data may be used to train image quality-linked machine-learning processes, models, and/or classifiers as described in further detail below.

Referring still to FIG. 1, training data, images, and/or other elements of data suitable for inclusion in training data may be stored, without limitation, in an image database. Image database may include any data structure for ordered storage and retrieval of data, which may be implemented as a hardware or software module. Image database may be implemented, without limitation, as a relational database, a key-value retrieval datastore such as a NOSQL database, or any other format or structure for use as a datastore that a person skilled in the art would recognize as suitable upon review of the entirety of this disclosure. An image database may include a plurality of data entries and/or records corresponding to user tests as described above. Data entries in an image database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in an image database may reflect categories, cohorts, and/or populations of data consistently with this disclosure. Image database may be located in memory 104 of apparatus 100 and/or on another device in and/or in communication apparatus 100.

Still referring to FIG. 1, an exemplary embodiment of an image database is illustrated. One or more tables in image database may include, without limitation, an image table, which may be used to store images, with links to origin points and/or other data stored in image database and/or used in training data as described in this disclosure. Image database may include an image quality table, where categorization of images according to image quality levels, for instance for purposes of use in image quality-linked training data, may be stored. Image database may include a demographic table; demographic table may include any demographic information concerning users from which images were captured, including without limitation age, sex, national origin, ethnicity, language, religious affiliation, and/or any other demographic categories suitable for use in demographically linked training data as described in this disclosure. Image database may include an anatomical feature table, which may store types of anatomical features, including links to diseases and/or conditions that such features represent, images in image table that depict such features, severity levels, mortality and/or morbidity rates, and/or degrees of acuteness of associated diseases, or the like. Persons skilled in the art, upon reviewing the entirety of this disclosure, will be aware of various alternative or additional data which may be stored in image database.

Still referring to FIG. 1, processor 108 may receive authorization credentials 120 that may include authorization image data. Image data may include pixel data of varying range. In instances where authorization image data does not match stored pixel data, processor 108 may transform authorization image data to stored pixel data. In some embodiments, to authenticate verifier 116, processor 108 may compare authorization image data to stored pixel data. In some instances, authorization image data may be transformed from its original state. Processor 108 may compare original authorization image data to stored pixel data. Authorization image data may differ in pixel count, thus, only a percentage of pixel data may match up. As a non-limiting example, at least 90 percent of pixel data may match. It should be noted that a percent match may be at least 95 percent, at least 90 percent, at least 80 percent, or the like. Processor may flag any verifier 116 that sends authorization credentials 120 that have less than the specified amount of pixel data matchup.

Still referring to FIG. 1, authorization credentials 120 may be digital signatures. As a non-limiting example, verifier 116 may use a device capable of fingerprinting. In some instances, authorization credentials 120 may be a digital fingerprint. In some embodiments, digital fingerprint may be a digital scan of verifier 116 finger, face, or any identifying feature. Digital fingerprint may be stored in a database and retrieved upon processor 108 receiving authorization credentials 120 from verifier 116. Digital fingerprint received from verifier 116 may be compared to a stored fingerprint associated with verifier 116 using methods described above. In some instances, digital fingerprint may be an image of an identifying feature. A certainty percentage threshold may be lower for an image of identifying feature in comparison to a digital fingerprint to account for confounding variables including but not limited to camera quality, formatting, transmission packet loss, or the like.

With continued reference to FIG. 1, processor 108 may receive an IP address associated with a known location of verifier 116. Authorization credentials 120 may include IP address. In some embodiments, IP address may be appended to any data packet containing authorization credential 120 data. In some instances, time elapsed during data transmission may be used to authenticate verifier 116. As a non-limiting example, time elapsed may be the time it takes for a data packet to be transmitted between a computing device associated with verifier 116 and processor 108. In some embodiments, time elapsed may be the time it takes for a first data packet to be transmitted from a computing device associated with verifier 116 to processor 108 and a second data packet transmitted from processor 108 to verifier 116. Processor 108 may authenticate verifier 116 as a function of time elapsed by comparing actual time elapsed to an expected time elapsed. Expected time elapsed may be calculated as function of network latency, expected data packet size, and the like. In instances of fraud attempts, processor 108 may determine that time elapsed is below a certainty percentage threshold as described above. As a non-limiting example, a spoof account may be located in different location than verifier 116. Therefore, data packet transmission may take more or less time than expected. Accordingly, processor 108 may flag spoof account as fraudulent. In some instances, a fraudulent verifier may use a proxy server to attempt to authenticate themselves. Data packet transmission may take more or less time than expected. Accordingly, processor 108 may flag fraudulent verifier as fraudulent. It should be noted that IP addresses associated with flagged accounts may be stored in a database to preserve computational resources if multiple fraudulent attempts come from the same account. As a non-limiting example, processor 108 may receive fraudulent authorization credentials 120 data packet with a flagged IP address appended to the data packet. Processor 108 may compare the data packet to stored flagged IP addresses. If the IP address appended to the data packet matches a stored flagged IP address, processor 108 may not authenticate verifier. It should be noted that flagged IP addresses may be added manually by first entity 124, second entity 128, or both.

With continued reference to FIG. 1, payout 144 may be determined by using life event data 112, first entity 124 data, second entity 128 data, and authorized verifier 116. Payout 144 may be determined by processor 108 receiving insurance policy data (i.e., life event data 112) that may include an insured person(s) information and their respective beneficiaries. In some instances, insurance policy may include more than one beneficiary. Thus, payout 144 may be split between each beneficiary based on percentages outlined within the insurance policy or equally by default. In some embodiments, processor 108 may receive insurance policy and verify that parties included in the insurance policy are also associated with first entity 124 and second entity 128. Upon verifying first entity 124 and second entity 128 are associated with insurance policy, second entity 128 may be required to input a request for verification of one or more claims to processor 108. Verifying second entity 128 may include scanning account data for identity verifies (e.g., social security number, name, transactions, location data). It should be noted that in some instances, there may be more than one second entity 128 and each entity may be required to submit separate requests. Processor 108 may then send a request to verifier 116 to provide authorized credentials 120 to first verify that verifier 116 is an authorized user, and then to verify the one or more claims submitted by second entity 128. Upon completion of both identification and claim verification, first entity may issue payout 144. In instances where there may be more than one second entity 128, only one request may need to be verified by verifier 116. After that, any subsequent request may only require verification of second entity 128.

Still referring to FIG. 1, payout 144 may be a predetermined amount based on a user's policy. In some instances, user's policy may have time-dependent variables that may cause payout 144 to be higher or lower than a predetermined amount. As a non-limiting example, payout 144 may increase over time for a user without many hospital visits. On the other hand, payout 144 may decrease if a user has a chronic illness. In some embodiments payout 144 may be a lump-sum fixed amount, specific income payout, retained asset account, annuity, and the like. Processor 108 may issue payout 144 to second entity 128 in various forms. In some embodiments, payout 144 may be electronic fund transfers (EFTs). As used in this disclosure, “electronic fund transfer” is a transfer of funds is initiated through an electronic terminal, telephone, computer (including on-line banking) or magnetic tape for the purpose of ordering, instructing, or authorizing a financial institution to debit or credit a consumer's account. EFTs include but are not limited to point-of-sale (POS) transfers; automated teller machine (ATM) transfers; direct deposits or withdrawals of funds; transfers initiated by telephone; and transfers resulting from debit card transactions, whether or not initiated through an electronic terminal. Accordingly, second entity 128 data may include bank account data such that payout 144 may be routed correctly.

Still referring to FIG. 1, payout 144 may be done by mail. In some embodiments, second entity data 128 may include a home address so that first entity 124 may send a check or voucher as payout 144. Check or voucher may be to the order of a primary name associated with second entity 128. Although payout 144 may be issued quicker than traditional payouts due to the identity verification, receiving payout may take longer, depending on method of delivery. It should be noted that EFT may happen faster than a check or voucher.

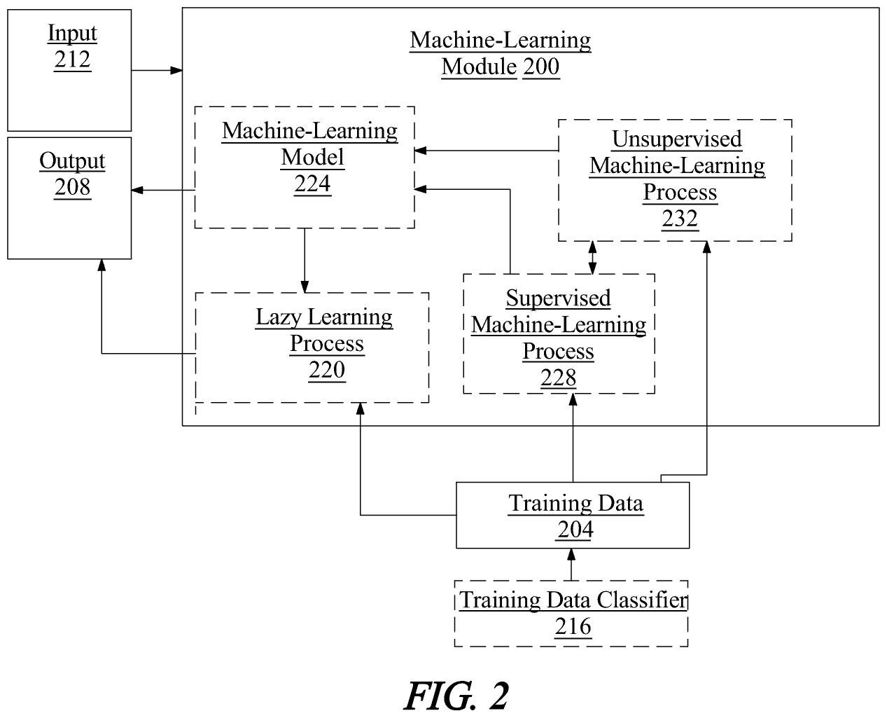

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example life event data 112, first entity 124, second entity 128, verifier 116, authorization credentials 120, or any combination thereof may be inputs to a payout machine learning model 136 to output payout 144.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 200 may generate a classifier using a classification algorithm, defined as a process whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data to types of payouts, delivery method of payouts, payout amounts, time elapsed from initial payout request, types of life event data (such as cause of death), number of beneficiaries, or things of the like. [something that characterizes a sub-population, such as a cohort of persons and/or other analyzed items and/or phenomena for which a subset of training data may be selected].

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include life event data 112, first entity 124, second entity 128, verifier 116, or the like as described above as inputs, payout 144 as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Referring now to FIG. 3, an exemplary embodiment of neural network 300 is illustrated. A neural network 300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

Referring now to FIG. 4, an exemplary embodiment of a node 400 of a neural network is illustrated. A node may include, without limitation a plurality of inputs xᵢ that may receive numerical values from inputs to a neural network containing the node and/or from other nodes. Node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights w′, may be determined by training a neural network using training data, which may be performed using any suitable process as described above.

Referring to FIG. 5, an exemplary embodiment of fuzzy set comparison 500 is illustrated. A first fuzzy set 504 may be represented, without limitation, according to a first membership function 508 representing a probability that an input falling on a first range of values 512 is a member of the first fuzzy set 504, where the first membership function 508 has values on a range of probabilities such as without limitation the interval [0,1], and an area beneath the first membership function 508 may represent a set of values within first fuzzy set 504. Although first range of values 512 is illustrated for clarity in this exemplary depiction as a range on a single number line or axis, first range of values 512 may be defined on two or more dimensions, representing, for instance, a Cartesian product between a plurality of ranges, curves, axes, spaces, dimensions, or the like. First membership function 508 may include any suitable function mapping first range 512 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

Still referring to FIG. 5, first fuzzy set 504 may represent any value or combination of values as described above, including output from one or more machine-learning models, image data, device identification, verifier location, network latency, and a predetermined class, such as without limitation of authenticated verifier. A second fuzzy set 516, which may represent any value which may be represented by first fuzzy set 504, may be defined by a second membership function 520 on a second range 524; second range 524 may be identical and/or overlap with first range 512 and/or may be combined with first range via Cartesian product or the like to generate a mapping permitting evaluation overlap of first fuzzy set 504 and second fuzzy set 516. Where first fuzzy set 504 and second fuzzy set 516 have a region 528 that overlaps, first membership function 508 and second membership function 520 may intersect at a point 532 representing a probability, as defined on probability interval, of a match between first fuzzy set 504 and second fuzzy set 516. Alternatively or additionally, a single value of first and/or second fuzzy set may be located at a locus 536 on first range 512 and/or second range 524, where a probability of membership may be taken by evaluation of first membership function 508 and/or second membership function 520 at that range point. A probability at 528 and/or 532 may be compared to a threshold 540 to determine whether a positive match is indicated. Threshold 540 may, in a non-limiting example, represent a degree of match between first fuzzy set 504 and second fuzzy set 516, and/or single values therein with each other or with either set, which is sufficient for purposes of the matching process; for instance, threshold may indicate a sufficient degree of overlap between an output from one or more machine-learning models and/or image data, device identification, verifier location, network latency, and a predetermined class, such as without limitation authenticated verifier categorization, for combination to occur as described above. Alternatively or additionally, each threshold may be tuned by a machine-learning and/or statistical process, for instance and without limitation as described in further detail below.

Further referring to FIG. 5, in an embodiment, a degree of match between fuzzy sets may be used to classify an image data, device identification, verifier location, network latency with an authenticated verifier. For instance, if a authenticated verifier has a fuzzy set matching image data, device identification, verifier location, or network latency fuzzy set by having a degree of overlap exceeding a threshold, processor 108 may classify the image data, device identification, verifier location, or network latency as belonging to the authenticated verifier categorization. Where multiple fuzzy matches are performed, degrees of match for each respective fuzzy set may be computed and aggregated through, for instance, addition, averaging, or the like, to determine an overall degree of match.

Still referring to FIG. 5, in an embodiment, an image data, device identification, verifier location, network latency may be compared to multiple authenticated verifier categorization fuzzy sets. For instance, image data, device identification, verifier location, network latency may be represented by a fuzzy set that is compared to each of the multiple authenticated verifier categorization fuzzy sets; and a degree of overlap exceeding a threshold between the image data, device identification, verifier location, network latency fuzzy set and any of the multiple authenticated verifier categorization fuzzy sets may cause processor 108 to classify the image data, device identification, verifier location, network latency as belonging to authenticated verifier categorization. For instance, in one embodiment there may be two authenticated verifier categorization fuzzy sets, representing respectively authenticated verifier categorization and an non-authenticated verifier categorization. First authenticated verifier categorization may have a first fuzzy set; Second authenticated verifier categorization may have a second fuzzy set; and image data, device identification, verifier location, network latency may have an image data, device identification, verifier location, network latency fuzzy set. Processor 108, for example, may compare an image data, device identification, verifier location, network latency fuzzy set with each of authenticated verifier categorization fuzzy set and in authenticated verifier categorization fuzzy set, as described above, and classify a image data, device identification, verifier location, network latency to either, both, or neither of authenticated verifier categorization or in authenticated verifier categorization. Machine-learning methods as described throughout may, in a non-limiting example, generate coefficients used in fuzzy set equations as described above, such as without limitation x, c, and σ of a Gaussian set as described above, as outputs of machine-learning methods. Likewise, image data, device identification, verifier location, network latency may be used indirectly to determine a fuzzy set, as image data, device identification, verifier location, network latency fuzzy set may be derived from outputs of one or more machine-learning models that take the image data, device identification, verifier location, network latency directly or indirectly as inputs.

Still referring to FIG. 5, a computing device may use a logic comparison program, such as, but not limited to, a fuzzy logic model to determine a authenticated verifier response. An authenticated verifier response may include, but is not limited to, very unlikely, unlikely, likely, and very likely, and the like; each such authenticated verifier response may be represented as a value for a linguistic variable representing authenticated verifier response or in other words a fuzzy set as described above that corresponds to a degree of matching as calculated using any statistical, machine-learning, or other method that may occur to a person skilled in the art upon reviewing the entirety of this disclosure. In other words, a given element of image data, device identification, verifier location, network latency may have a first non-zero value for membership in a first linguistic variable value such as “very likely” and a second non-zero value for membership in a second linguistic variable value such as “very unlikely” In some embodiments, determining a authenticated verifier categorization may include using a linear regression model. A linear regression model may include a machine learning model. A linear regression model may be configured to map data of image data, device identification, verifier location, network latency, such as degree of . . . to one or more authenticated verifier parameters. A linear regression model may be trained using a machine learning process. A linear regression model may map statistics such as, but not limited to, quality of image data, device identification, verifier location, network latency . . . . In some embodiments, determining an authenticated verifier of image data, device identification, verifier location, network latency may include using a authenticated verifier classification model. An authenticated verifier classification model may be configured to input collected data and cluster data to a centroid based on, but not limited to, frequency of appearance, linguistic indicators of quality, and the like. Centroids may include scores assigned to them such that quality of . . . of image data, device identification, verifier location, network latency may each be assigned a score. In some embodiments authenticated verifier classification model may include a K-means clustering model. In some embodiments, authenticated verifier classification model may include a particle swarm optimization model. In some embodiments, determining the authenticated verifier of an image data, device identification, verifier location, network latency may include using a fuzzy inference engine. A fuzzy inference engine may be configured to map one or more image data, device identification, verifier location, network latency data elements using fuzzy logic. In some embodiments, image data, device identification, verifier location, network latency may be arranged by a logic comparison program into authenticated verifier arrangement. An “authenticated verifier arrangement” as used in this disclosure is any grouping of objects and/or data based on skill level and/or output score. This step may be implemented as described above in FIGS. 1-4. Membership function coefficients and/or constants as described above may be tuned according to classification and/or clustering algorithms. For instance, and without limitation, a clustering algorithm may determine a Gaussian or other distribution of questions about a centroid corresponding to a given degree of matching level, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Further referring to FIG. 5, an inference engine may be implemented according to input and/or output membership functions and/or linguistic variables. For instance, a first linguistic variable may represent a first measurable value pertaining to image data, device identification, verifier location, network latency, such as a degree of matching of an element, while a second membership function may indicate a degree of in authenticated verifier of a subject thereof, or another measurable value pertaining to image data, device identification, verifier location, network latency. Continuing the example, an output linguistic variable may represent, without limitation, a score value. An inference engine may combine rules, such as: “if image is likely this verifier, device is highly likely the verifier's device, location is likely correct, and network latency is likely correct, then verifier is highly likely to be identified”—the degree to which a given input function membership matches a given rule may be determined by a triangular norm or “T-norm” of the rule or output membership function with the input membership function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥,” such as max(a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively or additionally, output rules may be replaced with functions according to the Takagi-Sugeno-King (TSK) fuzzy model.

Further referring to FIG. 5, image data, device identification, verifier location, network latency to be used may be selected by user selection, and/or by selection of a distribution of output scores, such as 100% very likely, 100% very unlikely, or the like. Each authenticated verifier categorization may be selected using an additional function such as inauthenticated verifier as described above.

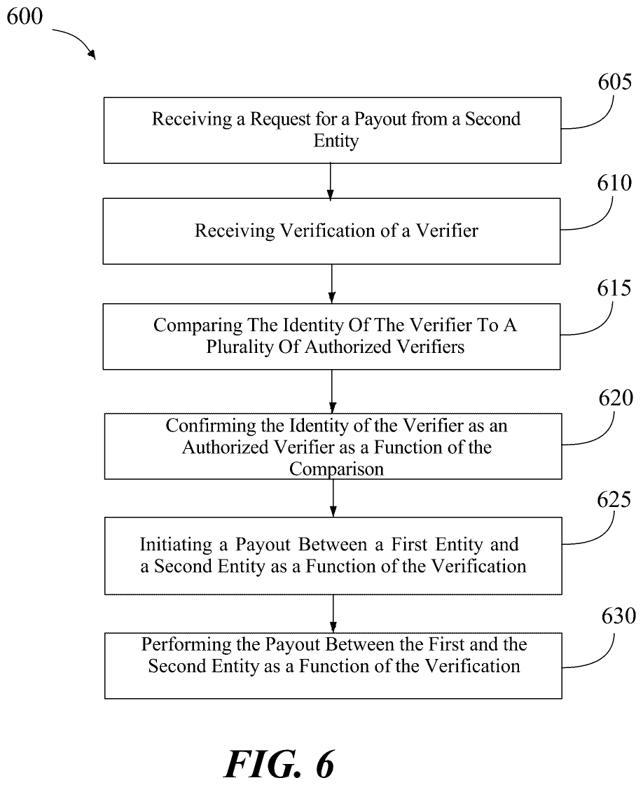

Referring to FIG. 6, an exemplary method 600 for identification using third-party verifiers. Method 600 incudes a step 605, receiving a request for a payout from a second entity. In some embodiments, receiving the request may include receiving policy data associated with the first entity and second entity. In some embodiments, receiving the request may include receiving a selection of payout type This may occur as described above in reference to FIGS. 1-5.

With continued reference to FIG. 6, method 600 includes a step 610 of receiving verification of a verifier. In some embodiments, verifying the verifier further comprises receiving image data from the verifier and comparing image data from the verifier to image data associated with one or more authorized users. In some embodiments, verifying the verifier further comprises receiving a textual input from a verifier and comparing at least a character string from the verifier to character strings associated with one or more authorized users. In some embodiments, verifying the verifier is confirmed using a plurality of approved credentials. In some embodiments, verifying the verifier further comprises using the plurality of approved credentials from the first entity to confirm the verifier. In some embodiments, the plurality of authorized verifiers is authorized by the first entity based on an identity of the second entity. In some embodiments, verification of verifier may be accomplished by using a machine learning model. This may occur as described above in reference to FIGS. 1-5.

With continued reference to FIG. 6, method 600 includes a step 615 of comparing the identity of the verifier to a plurality of authorized verifiers. In some instances, identity of the verifier may be confirmed by facial recognition, textual input, using a plurality of approved credentials, or the like. This may occur as described above in reference to FIGS. 1-5.

With continued reference to FIG. 6, method 600 includes a step 620 of confirming the identity of the verifier as an authorized verifier as a function of the comparison. This may occur as described above in reference to FIGS. 1-5.

With continued reference to FIG. 6, method 600 includes a step 625 of initiating a payout between a first entity and a second entity as a function of the verification. Payout may include but is not limited to a predetermined amount, a lump-sum fixed amount, or the like. This may occur as described above in reference to FIGS. 1-5.

With continued reference to FIG. 6, method 600 includes a step 630 of performing the payout between the first entity and the second entity as a function of the verification. In some embodiments, payout is performed within a certain time period after verification (e.g., 24 hours, 48 hours, 72 hours). This may occur as described above in reference to FIGS. 1-5.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

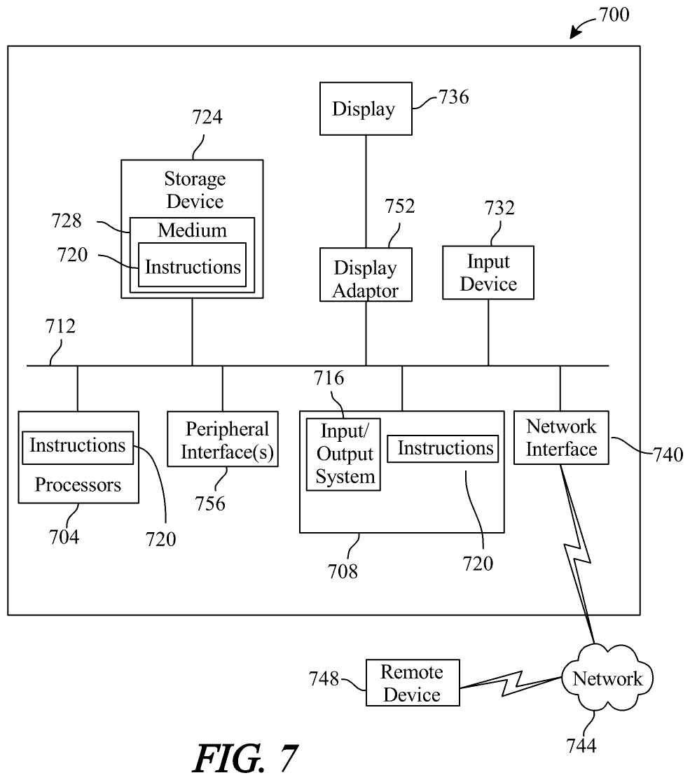

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A method for identification using third-party verifiers, the method comprising:
receiving, by a processor, a request for a payout and life event data from a second entity;
verifying, by the processor, the life event data as a function of an authorization credential comprising image data associated with a verifier, wherein verification of the life event data comprises:
converting a pixel count of the at least an image into a required pixel count for an input;
processing the authorization credential as a function of a set of interpolation rules, wherein processing the authorization credential comprises:
generating an image classifier using a required pixel count input wherein the image classifier comprises the set of interpolation rules trained by sets of highly detailed images and images that have been down sampled to smaller pixels, wherein generating the image classifier further comprises:
training the image classifier using training data correlating sample picture inputs to pseudo replica sample-picture outputs;
inputting the required pixel count into the image classifier;
classifying the required pixel count to the authorization credential using the image classifier; and
verifying the authorization credential as a function of a classification of the required pixel count;
generating, by the processor, one or more cryptographic hashes that are representative of the verification of the life event data;
initiating, by the processor, the payout between a first entity and the second entity as a function of the verification of the life event data and the request; and
performing, by the processor, the payout between the first entity and the second entity as a function of the verification of the life event data.

2. The method of claim 1, wherein classifying the at least an image further comprises down-sampling the at least an image to a desired pixel count.

3. The method of claim 1, wherein classifying the at least an image further comprises using chroma averaging to fill in pixels in a pixel array.

4. The method of claim 1, wherein classifying the at least an image further comprises adding dummy pixels to a pixel array.

5. The method of claim 1, wherein verifying the life event data further comprises receiving a textual input from a verifier and comparing at least a character string from the verifier to character strings associated with one or more authorized users.

6. The method of claim 1, wherein confirming an identity of the verifier is a function of time elapsed during a data packet transmission.

7. (canceled)

8. (canceled)

9. (canceled)

10. (canceled)

11. An apparatus for identification using third-party verifiers, comprising:
a processor; and
a memory communicatively connected to the processor, the memory comprising instructions that when executed by the processor, cause the processor to:
receiving a request for a payout and life event data from a second entity;
verifying the life event data as a function of an authorization credential comprising image data associated with a verifier, wherein verification of the life event data comprises:
converting a pixel count of the at least an image into a required pixel count for an input;
processing the authorization credential as a function of a set of interpolation rules, wherein processing the authorization credential comprises:
generating an image classifier using a required pixel count input wherein the image classifier comprises the set of interpolation rules trained by sets of highly detailed images and images that have been down sampled to smaller pixels, wherein generating the image classifier further comprises:
training the image classifier using training data configured to correlate sample picture inputs to a pseudo replica sample-picture output;
inputting the required pixel count into the image classifier;
classifying the required pixel count to the authorization credential using the image classifier; and
verifying the authorization credential as a function of a classification of the required pixel count;
generating one or more cryptographic hashes that are representative of the verification of the life event data;
initiating the payout between a first entity and the second entity as a function of the verification of the life event data and the request; and
performing the payout between the first entity and the second entity as a function of the verification.

12. The apparatus of claim 11, wherein classifying the at least an image further comprises down-sampling the at least an image to a desired pixel count.

13. The apparatus of claim 11, wherein classifying the at least an image further comprises filling in pixels in a pixel array utilizing chroma averaging.

14. The apparatus of claim 11, wherein confirming an identity of the verifier is a function of time elapsed during a data packet transmission.

15. The apparatus of claim 11, wherein verifying the life event data further comprises receiving a textual input from the verifier and comparing at least a character string from the verifier to character strings associated with one or more authorized users.

16. The apparatus of claim 11, wherein an identity of the verifier is confirmed using a plurality of approved credentials.

17. The apparatus of claim 16, wherein verifying the life event data further comprises confirming the verifier utilizing the plurality of approved credentials from the first entity.

18. The apparatus of claim 11, wherein a plurality of authorized verifiers is authorized by the first entity based on an identity of the second entity.

19. The apparatus of claim 11, wherein the authorization credential is a digital fingerprint.

20. (canceled)

21. The method of claim 1, wherein a plurality of authorized verifiers is authorized by the first entity based on an identity of the second entity.

22. The method of claim 1, wherein the authorization credential is a digital fingerprint.

23. (canceled)
